(19) United States
(12) Patent Application Publication
(10) Pub. No.: US 2020/0051018 A1
(43) Pub. Date: Feb. 13, 2020

(54) System and Method for Automatic Disposition of Articles

(71) Applicant: The Recon Group LLP, Miami, FL (US)

(72) Inventor: Sender Shamiss, Sunny Isles, FL (US)

(73) Assignee: The Recon Group LLP, Miami, FL (US)

(21) Appl. No.: 16/058,536

(22) Filed: Aug. 8, 2018

(51) Int. Cl. G06Q 10/08; B65G 47/49; B65G 47/88

(52) U.S. Cl. CPC G06Q 10/0837; B65G 47/8823; B65G 47/493; G06Q 10/087

(57) ABSTRACT

The present disclosure concerns a system and a related method for the automatic disposition of articles. The system can combine information on the identity of an arbitrary article, price data, cost data and disposition rules to determine the disposition of the article and effect a physical change in a switch that represents the disposition determination. The switch can be associated with a diverter swing arm. The system can, moreover, determine the identity of the article and label the article in real time, having determined the disposition of the article between article identification and article labeling. The disposition determination can provide a rationale for sortation.

### FIELD OF THE INVENTION

The present disclosure relates to reverse logistics, and more specifically to a system and method for automatic disposition of articles.

### BACKGROUND OF THE INVENTION

US total retail sales amounted to $5.1 trillion in 2017, according to the US Census Bureau. The retail value of returned department-store goods was $270 billion, based on US Census Bureau data and industry surveys. Consumers made 9% of all retail purchases online and returned 9% of all brick-and-mortar sales purchases and 30% of all E-commerce purchases. Perspective on the numbers can be gained by illustration.

Suppose the average retail price of any returned item of merchandise was $50. This will translate into 5 billion returned items in 2017. If each return transaction involved 2 items on the average, there was nearly 1 such transaction per month for every American of any age, or 7.4 million return transactions per day—nearly 90 per second—every hour of every day of the year, including holidays. The numbers provide insight on the business opportunities and challenges in reverse logistics.

It is not hard to see how. A reverse logistics entity might aim to provide services for the disposition of returned department-store goods. The services could include maximizing recovery of value, minimizing environmental footprint, and so on. The range of disposition options could include return to shelf, return to vendor, liquidate, salvage, donate and destroy (send to landfill). The entity might set itself the seemingly modest aim of capturing just 1% of the current returned consumer goods market.

On the 2017 data, 1% of the market will translate into nearly 1 return transaction per second. Given an average processing time of 1 minute, the need will be 60 personnel—for consumer management alone. A more realistic processing time of 2 minutes equates to 120 such persons, 24 hours per day, or 360 such persons for 8-hour days, excluding breaks, 365 days per year, or over 500 such persons for weekdays only. These employees will not handle goods—receive, position, warehouse, grade, clean, refurbish, remanufacture, assess for environmental hazard, accessorize, pick, pack, ship, parts harvest or destroy—just tend to defined aspects of consumer service. But payroll will not suddenly stop being the most common largest expense of an organization. Moreover, for the reverse logistics entity just to maintain its market position, it will have to hire more such persons, beyond coping with sick leave, maternity leave, paid time off and personnel turnover. That is because the percentage of consumer goods returned is rising around 10% per year, thanks largely to the success of E-commerce. This trend is expected to continue for years to come.

The complexity of the consumer retail reverse logistics industry is even greater than the foregoing suggests. Tens of millions of different products, each uniquely identified (for example, by a Universal Product Code, or UPC), are purchased daily in US brick-and-mortar or online stores. This alone poses a massive data-management challenge for retailers of general merchandise in the primary market. The secondary market is marked by an added challenge: dealing with a variety of grades of goods, ranging from “new” to “like-new,” “good,” “poor” and “salvage” articles, not to say a multitude of different conditions that correspond to the same grade. Practical difficulty is increased by the numerous possible options for product disposition, each making a different contribution to asset value recovery and posing its own logistical and environmental concerns.

The large growth in volume of returned consumer goods is making retailers think twice. Competitiveness in the primary and the secondary markets increasingly depends not only on product salability, customer service and regulatory compliance but also on sound and pragmatic decision-making on inventory items that, in times past, executives just regarded as a business expense and managers simply sent to landfill. A large amount of reliable data is needed to assess the likely recovery value for each item.

Primary market sellers, reverse logistics companies and secondary market sellers to be ready and able to process massive amounts of data and materials in ways that make sound business sense in relation to the reverse flow of consumer retail goods. The data must be current and product-specific. The data must encompass market prices, handling costs, regulatory requirements and proprietary disposition rules. Some goods might not be worth the effort to justify “white-glove” processing, say, grading, cleaning and accessorizing prior to listing for sale in a business-to-consumer marketplace, but could still be sold on a pallet or in a truckload in a business-to-business transaction. Every “touch” of an article increases the handling cost and reduces the potential for value recovery. Data are needed for every UPC in the catalog, which might contain dozens of data points for millions, tens of millions, or more than 100 million products. In fact, there were about 75 million different products for sale on Walmart's E-commerce site in April 2018.

The foregoing makes it clear enough that a reverse logistics entity will have to automate some aspects of its business just to keep current. Automation will also be desirable, if not necessary, for commercial competitiveness. A massive shift in the deeply-held expectation among US consumers that retailers should allow the return of most items purchased—for a wide range of reasons, for a substantial time after purchase, and often without proof of purchase—is not expected soon.

For such reasons and others, it is desirable to develop improved systems and methods for automating and optimizing aspects of secondary goods processing. Despite advances in this area, further improvements are possible.

### SUMMARY OF THE INVENTION

In view of the foregoing, it is an object of the present disclosure to provide an improved system and related method for the automatic selection of the best disposition option for an article based on data (e.g. price data and cost data) and rules (e.g. applicable regulation and required recovery of asset value). In essence, “sheep” are sorted from “goats,” articles likely from articles unlikely to yield above a minimum amount or percentage of retail value. Sorting can precede grading to reduce the number of “touches” of inventory and thus net processing cost. Articles thus sorted can be sorted further, for example, according to the goods classification scheme of the Nice Agreement.

In an aspect of the present invention, a system for the automatic disposition of an article comprises at least one database, a processor and one or more switches. The database is configured for storing price data, cost data and disposition rules related to at least one article. The processor is configured for accessing price data, cost data and disposition rules in relation to an article from the at least one database, comparing the received price data and cost data, determining a disposition for the article based on the data comparison and disposition rules, and transmitting a signal indicating the disposition decision to one or more switches. The one or more switches are configured for receiving the disposition decision signal from the processor and generating a physical indication of the disposition decision.

In an embodiment of the present invention, the automatic disposition of an article involves a processor, at least one database, and one or more switches. The processor retrieves from the at least one database cost data, price data and disposition rules pertaining to the article, compares by the processor the retrieved cost data and price data, determines by the processor a disposition decision based on the data comparison and the retrieved disposition rules, and transmits by the processor a signal indicating the disposition decision to the one or more switches.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a schematic diagram of the system of the present disclosure.

FIG. 2 is a schematic diagram of the system of the present disclosure in association with a conveyor and related devices.

FIG. 3 is a flowchart of a representative method of the present disclosure.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

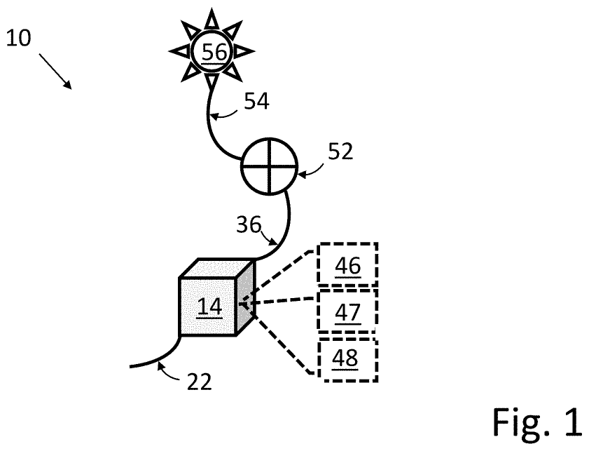

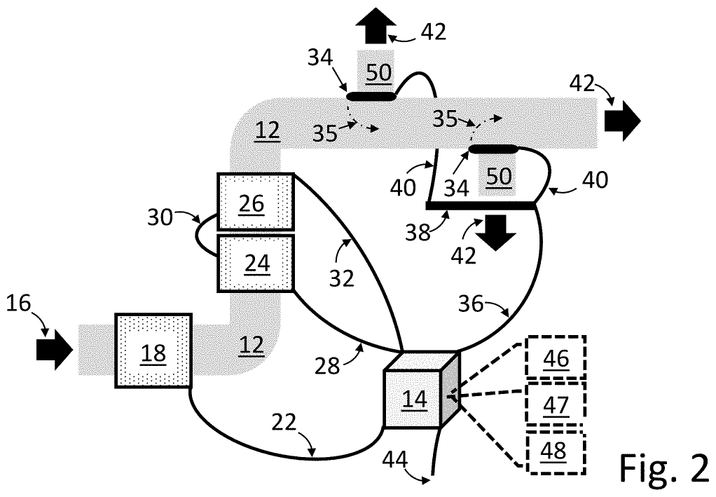

Referring to FIGS. 1 and 2, a system 10 for the automatic disposition of an article comprises a processor 14, databases 46-48, and one or more switches 52. The processor 14 is configured for receiving data pertinent to the identity of the article, comparing the article-specific data, and making a disposition decision based on the data comparison. The data can come from one or more article ID reading devices 18 (e.g. via electrical cable 22), a price database 46, a cost database 47 and a set of disposition rules 48, and/or a source on the internet (e.g. via electrical cable 44). The one or more switches 52 are configured for communicating electronically with the processor 14 and giving a physical indication of the disposition decision (e.g. via an electrical cable 54 and an indicator 56). In one embodiment of the present invention, a switch 52 can give a physical indication of the disposition decision by effecting the rotation of a swing arm diverter 34 in the direction indicated by the respective arrow 35 (in which embodiment a swing arm diverter 34 of FIG. 2 is the indicator 56 of FIG. 1). Rotating a swing arm diverter 34 can divert a first article on a conveyor 12 from an initial direction of motion (indicated e.g. by arrow 16) to a final direction motion (indicated e.g. by the respective arrow 42) on the respective diversion chute 50. The swing arm diverter 34 can now be reset by rotation in a direction opposite to that indicated by the respective arrow 35 and readied to divert a second article.

‘ID reading device’, a term noted above, means when utilized herein an “identification reading device, for example, an automatic identification and data capture (AIDC) reader, scanner or interrogator.” AIDC is a process for or means of automatic identification or tracking of an article based on image data, video data, sound data, electronic data, magnetic data or the like read from coded information displayed on, or stored in a tag attached to, the article. A large percentage of all cans, books, shoes and car parts sold are or could be equipped with an identifying code that can be read by one or more AIDC methods.

There are three main components of an AIDC method: 1) a data encoder, 2) a data reader and 3) a data decoder. All data must be encoded in a machine-readable format. In a typical case, a label displaying or tag containing the encoded data is attached to an article to be identified. A reader (or scanner or interrogator) is a device that performs AIDC (or automatic data capture, ADC, for identification), capturing the encoded data from the label or tag. The method of data capture will depend on the application. In cases a scanner both reads encoded data and converts it from one form to another. A data decoder, or transducer, transforms the scanned data into a desired display or storage format, often, alphanumeric characters. The decoded data can generally be analyzed or compared with other information sources to verify identity and stored.

Each AIDC method has its own kind of data carrier. Carrier types include optical, machine-readable codes [e.g. UPCs, other kinds of barcode, quick response (QR) codes, other one- or two-dimension optical codes], characters (as in optical character recognition), active and passive radio-frequency identification tags (RFIDs), magnetic strips, and other forms of machine-readable representations of code. Other significant terms of the present disclosure are ‘cost data’, ‘price data’ and ‘disposition rules’.

‘Cost data’ can include the cost of the following: receiving, positioning warehousing, grading/cleaning/accessorizing, refurbishing, remanufacturing, assessing for environmental hazard and picking/packing/shipping an article. ‘Price data’ can include the price of any of the following: competitor pricing, available quantity, sales velocity, page ranking, purchase history, product lifetime, product launch data, price changes for related and similar products, current and historical trends, seasonal forecast, opinion reviews, media mentions, correlations between related and similar products, and proprietary/internal factors. Disposition rules' can include any of the following: conditions under which an article is returned to shelf, conditions under which an article is returned to vendor, conditions under which a coupon is honored, conditions under which hazardous materials regulation applies to article handling, conditions of price and/or cost under which an article is prepared for resale, salvage, donation, remanufacturing, refurbishment, parts harvesting and the like.

In another embodiment of the present invention, a conveyor 12 is configured first to receive an article in the direction 16, next to pass the article by one or more ID reading devices 18, and next to pass the article by one or more article labeling devices 24-26. One or more of the article labeling devices 24-26 can apply an adhesive label to the article. The label can include a proprietary identification number and reflect the disposition decision for the article. All devices 18 and 24-26 are configured (possibly by means of one or more communications interfaces, not shown) to be in electronic communication with a processor 14, for example, via electrical cables 22, 28 and 32 (FIG. 2). Electrical cable 30 provides a direct means of communication between the one or more article labeling devices 24-26.

In another embodiment of the present invention, a conveyor 12 is configured for possible article diversion to one or more diverter chutes 50 in a direction 42. Diversion can be effected by one or more diverter swing arms 34. Each diverter chute 50 is associated with up to one diverter swing arm 34. The one or more diverter swing arms 34 are configured (possibly by way of one or more communications interfaces, not shown) to be in electrical communication with a processor 14, for example, by electrical cables 36, 38 and 40 (FIG. 2). In this depiction of an exemplary embodiment of the present invention, electrical cable 38 functions as a communications bus, connecting each of the one or more diverter swing arms 34 via a respective electrical cable 40 to the processor 14 via the cable 36.

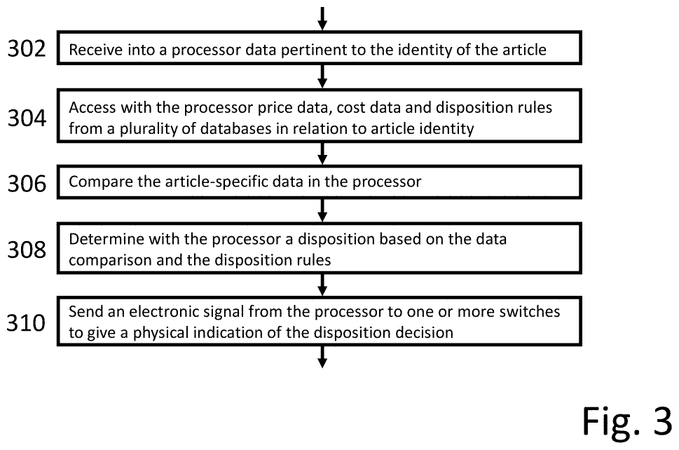

Referring to FIG. 3, in an embodiment of the present invention a processor 14 of the system 10 for the automatic disposition of an article receives data pertinent to the identity of the article at step 302.

At step 304, the processor 14 accesses price data, cost data and disposition rules in relation to article identity from a plurality of databases 46-48.

At step 306, the processor 14 compares the article-specific data.

At step 308, the processor 14 determines the disposition of the article based on the data comparison and the disposition rules.

At step 310, the processor 14 sends an electronic signal to one or more switches 52 to give a physical indication of the disposition decision. In an embodiment of the present invention, the physical indication of the disposition decision is the rotation of a swing arm diverter, the effect being to redirect the article from a first route to a second route and thus convert an electronic determination of disposition to a physical outcome.

As utilized herein, ‘article’ means “a member of a class of things,” and more specifically, “a thing, often an item of merchandise, the exterior surface of which can display an optical, machine-readable representation of data.”

‘Optical, machine-readable representation of data’ means “encoded information that can be read by a device that utilizes electromagnetic radiation in the visible range, near-UV range or near-IR range in the reading process.” The representation of data can be printed on a label attached to an article or screened, etched, peened or otherwise formed on a manufactured article. Numerous examples of such representations of data are noted herein.

‘Processor’ means “one or more components in a computer responsible for receiving input data, executing the instructions of one or more computer programs by performing basic arithmetic logical, control and input/output operations specified by the instructions, and carrying out related functions.”

‘RFID’ means “radio-frequency identification.” An RFID reader is a type of AIDC device. A typical UPC for a trade item or consumer product is limited to identifying only the manufacturer and class of product, whereas a typical RFID tag is designed for unique identification of each manufactured item. An RFID tag, in other words, offers data encoding capabilities well beyond a UPC. Manufacture and expiry dates can be encoded in an RFID tag, and read/write user memory is available in some types of RFID tag.

There are other advantages of RFID tags. No clear “line of sight” is required as in UPC reading; the article to which the RFID tag is attached can be inside a container. “Passive” RFID tags absorb energy from a nearby RFID reader's interrogating radio waves, whereas “active” RFID tags have a local power source (e.g. a battery) a can operate hundreds of meters away from an RFID reader.

RFID reading comprises scanning with an antenna, decoding data with a transceiver, and accessing data from a programmed transponder (a RFID tag). The reader/antenna detects an RFID tag in an interrogation field. The tag consists of an antenna and a microchip. The scanner emits an RF signal, enabling communication with the transponder (RFID tag) and providing energy for the transponder to communicate. The RFID tag detects an activation signal from the antenna, activating the chip, and the antenna transmits its data to the reader.

‘Scan’ means “to use a device to read an optical, machine-readable representations of data.” A scan is productive if it results in an accurate reading of an optical, machine-readable representations of data.

‘Symbology’ means “the study or use of symbols, for example, machine-readable representations of data.” An example of a symbology is the UPC.

A UPC is a kind of barcode, a kind of machine-readable representation of data, or symbology, and more specifically, a discrete symbology. Barcode data are typically encoded in the width and spacing of a plurality of (light-absorbing) black lines on a (light-reflecting) white field. A line is a one-dimensional figure. The lines are elongated to increase the odds of accurate reading. Two-dimensional barcodes are known, as are similar codes involving rectangles, dots, hexagons or other geometric shapes. Important here, the principles whereby practical use is made of these codes are essentially the same as for UPCs.

In view of the foregoing, the kinds of optical, machine-readable representations of data that can be read by a system 10 of the present invention can be a UPC, any other type of barcode, a QR code, an Australian Post code, an Aztec code, a BPO code, a Canada Post code, a Codabar, a Codablock, a Code 11, a Code 39, a MSI Code, a PDF417, a Planet code, a Plessey code, a Postnet, a reverse logistics (RL) labeling code, a RSS, a Standard 2 of 5, a Telepen, a TLC 39, or any other optical, machine-readable, one- or two-dimensional representation of data for which practical use is essentially the same as for UPCs.

Moreover, text itself can be considered a type of optical, machine-readable representation of data, regardless of alphabet, script or font. This is because text can be read by optical character recognition (OCR) for a great variety of alphabets, scripts and fonts, for example, the characters in the ISO/IEC 10646 standard or a similar standard. Furthermore, the present system and method are not restricted to an alphabetic script, because reliable means exist for the OCR of pictograms, for example, simplified or traditional Chinese characters.

Diverse methods of reading optical, machine-readable representations of data and related devices are known in the art. Devices for UPC reading, for example, include pen-type scanners, laser scanners, charge-coupled device readers (or light-emitting diode scanners), video camera readers, large field-of-view readers, omnidirectional barcode scanners, and cell phone cameras. Certain general principles apply to all these cases, because all read a barcode by distinguishing between white lines and black lines and line width.

In the case of a typical optical barcode scanning device, a sensor of the device detects reflected light from the barcode and generates an analog signal. The electrical potential of the signal corresponds to the reflected light intensity, low intensity for a bar (black) and high intensity for a space between two bars (white). An electrical device then converts the analog signal to a digital form. The digital signal is decoded, and the decoded signal is validated by a check digit in the UPC and converted into standard characters, often a string of alphanumeric characters. These characters constitute the decoded data set.

In the case of a typical smartphone scanner, an application on a mobile device converts a digital image of a barcode into a corresponding string of characters. “White” pixels in the image correspond to one of the two levels of electrical potential in optical scanning, and “black” pixels correspond to the other level of electrical potential. The resolution of the imaging device must be high enough to provide an accurate representation of the widths of lines and spaces between lines.

The data encoded in a typical optical, machine-readable representation generally concern the article on which the representation is affixed. A UPC, for example, can be attached to a corresponding article by means of a printed and/or adhesive label. A printed UPC can be generated on demand and prepared with any convenient device.

Uses of UPCs and other optical, machine-readable representations of data include customer identification, lending library book identification, luggage identification and tracking, patient identification and tracking, and medication management. UPCs are especially useful for product authenticity verification, identification, inventory and tracking. The present system and method are potentially suitable for a variety of different applications, for example, point-of-sale inventory management, factory floor management and parcel sorting.

Many additional modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for the automatic disposition of an article, the system comprising:
at least one database configured for storing price data, cost data and disposition rules related to a plurality of articles;
a processor configured for:
accessing price data, cost data and disposition rules in relation to the article from the at least one database;
comparing the received price data and cost data;
determining a disposition for the article based on the data comparison and disposition rules; and
transmitting a signal indicating the disposition decision to one or more switches; and
one or more switches configured for:
receiving the signal indicating the disposition decision from the processor; and
generating a physical indication of the disposition decision.

2. The system of claim 1, wherein the article moves on a conveyor in signal communication with the processor, and the conveyor is configured to convey the article to a location based on the disposition decision.

3. The system of claim 1, wherein the system further includes at least one article ID reading device in signal communication with the processor, the at least one article ID reading device being configured to determine article ID and thus to facilitate accessing price data, cost data and disposition rules pertaining to the article from the at least one database.

4. The system of claim 3, wherein the at least one article ID reading device is positioned along a moving conveyor.

5. The system of claim 1, wherein the system further includes at least one article labeling device in signal communication with the processor, the at least one article labeling device being configured to apply a label on the article based on a comparison of cost data, price data and disposition rules pertaining to the article from the at least one database.

6. The system of claim 5, wherein the at least one article labeling device is positioned along a moving conveyor.

7. The system of claim 5, wherein the information content of at least one label applied to the article is based on the disposition decision.

8. The system of claim 1, wherein the at least one database is updated in real time or periodically with data from a third-party source.

9. The system of claim 1, wherein at least one of the one or more switches is configured to control the state of a light indicator.

10. The system of claim 1, wherein at least one of the one or more switches is configured to control the state of a swing arm diverter.

11. A method for the automatic disposition of an article involving a processor, at least one database, and one or more switches, the method comprising:
retrieving with the processor from the at least one database cost data, price data and disposition rules pertaining to the article;
comparing with the processor the retrieved cost data and price data;
determining with the processor a disposition decision based on the data comparison and the retrieved disposition rules; and
transmitting with the processor to the one or more switches a signal indicating the disposition decision.

12. The method of claim 11, wherein the retrieval of cost data, price data and disposition rules pertaining to the article from the at least one database is based on article identity.

13. The method of claim 12, wherein the article identity is determined by one or more ID reading devices.

14. The method of claim 13, wherein the article is on a moving conveyor and the one or more ID reading devices are positioned along the moving conveyor, such that the identity of the article can be determined by at least one of the one or more ID reading devices.

15. The method of claim 13, wherein at least one of the one or more article ID reading devices is configured for reading a machine-readable representation of code on or within the article, wherein the reading process includes:
capturing article ID data;
transferring article ID data to a processor;
analyzing article ID data; and
converting article ID data to a desired format.

16. The method of claim 13, wherein a label is applied to the article based on article ID.

17. The method of claim 16, wherein the label is applied by one or more article labeling devices.

18. The method of claim 11, where in the method further comprises diverting the article according to the disposition decision.

19. The method of claim 11, wherein the at least one database from which price data, cost data and disposition rules are retrieved is updated in real time.

20. The method of claim 11, wherein the at least one database includes primary and secondary market price data on a plurality of products, including products of the ID of the article and cost data on processing a plurality of products, including products of the ID of the article.
